(19) United States
(12) Patent Application Publication
(10) Pub. No.: US 2007/0215639 A1
(43) Pub. Date: Sep. 20, 2007

(54) Method and Apparatus for Dispensing Liquid with Precise Control

(76) Inventors: Benjamin R. Roberts, Los Altos, CA (US); David Alan Gerken, Chaska, MN (US); Bryan Lane Smith, Farmington, MA (US)

Correspondence Address: THE BOC GROUP, INC., 575 MOUNTAIN AVENUE, MURRAY HILL, NJ, 07974-2064, US

(21) Appl. No.: 11/674,253

(22) Filed: Feb. 13, 2007

Related U.S. Application Data
(60) Provisional application No. 60/773,448, filed on Feb. 15, 2006.

(51) Int. Cl. B67D 5/08; B65D 88/54

(52) U.S. Cl. 222/61; 222/63; 222/318

(57) ABSTRACT

The present invention provides methods and apparatus combining a pressure vessel and a centrifugal pump to accurately and efficiently control pressure and flow rate of liquid in a liquid dispense system. The present invention particularly relates to the accurate and efficient control of pressure and flow rate of liquids, such as high purity chemicals or slurries used in semiconductor manufacturing processes.

### FIELD OF THE INVENTION

The present application provides methods and apparatus for the delivery of liquids under conditions that require highly accurate control of pressure or flow rate. In particular, the present invention provides methods and apparatus for the delivery of high purity chemicals or slurries to one or more points of use in a semiconductor manufacturing process, wherein the flow rate of the chemical or slurry is provided at a constant flow rate to the points of use.

### BACKGROUND OF THE INVENTION

It is often desirable to precisely control the amount of liquid provided to an end point of a liquid dispensing system. Further, it is important that the amount of liquid provided is as constant as possible to avoid spiking that can have deleterious effects. This is particularly true for semiconductor manufacturing processes where the amount of liquid provided can greatly affect the process, such as layer formation, etching, cleaning, etc. Variations in pressure can lead to non-repeatability and ultimately a loss in yield. Flow control is also important. For certain processes, such as semiconductor processes requiring slurries, it is important to maintain the flow rate at a velocity necessary to keep particles suspended in the slurry. Alternatively, for high purity chemical applications, maintaining consistent flow rate is important to assure optimum filtration. Changes in flow rate can also affect the pressure in the distribution system, such as by frictional losses (e.g. headloss) in piping or filtration cartridges.

It is therefore desirable to provide a precise, controllable, constant flow rate of liquid to the points of use or end point of the dispensing system. However, this can be difficult to achieve for a number of reasons, including, variations in demand, pressure changes in the distribution system during operation, pressure changes caused by filter clogging, pump cycle effects, and others. To more fully explain the problems that must be overcome, FIG. 1 is provided to illustrate a basic liquid dispensing system as known in the prior art.

FIG. 1 shows a basic system 100, including a liquid dispense tank 10, a pump 20, and a point of use 30. In the system 100, the pump delivers liquid from tank 10, to the point of use 30. The tank 10 is typically a standard vented tank that may be refilled with liquid as needed from a liquid source 40. The pump 20 may be any standard type of pump, such as a positive displacement pump or an impeller pump. However, more recently, centrifugal pumps have been used for bulk chemical and slurry applications. This trend is even more recent in the semiconductor industry where because of purity concerns, only a limited number of centrifugal pumps have been accepted for use.

Centrifugal pumps are good at maintaining stable pressures for small liquid demands. However, large consumption demands or disruptions in the distribution system, e.g. charging an empty filter housing, can cause flow transients that significantly reduce the output pressure of the centrifugal pump and therefore significantly effect the pressure in the distribution system. Further, centrifugal pumps demand a high amount of electrical power and have limitations on discharge pressure. Reaching higher pressures requires more electrical power and centrifugal pumps running at the high RPMs needed for high pressure operation, can introduce heat into the system that may negatively impact some processes.

While only one point of use 30, is shown in FIG. 1, it will be recognized by those skilled in the art, that multiple points of use could be provided with liquid from the same dispensing system 100. However, as will also be recognized, additional points of use add to the complexity of the system and make it harder to maintain system pressure and flow rate. As will be noted in FIG. 1, excess liquid is provided through the distribution system 100, to help stabilize the flow rate and pressure at the point of use 30. In particular, liquid is delivered out of the tank 107 flows through the system 100, is provided in the required amount to the point of use 30, and any excess liquid flows back to the tank 10 for reuse. To better control system pressure or flow rate, a feed back loop may be provided. In particular, as shown in FIG. 1, a sensor 50, such as a pressure sensor or a flow meter, provides information indicative of the flow rate, which can be used to control the speed of the pump 20, or to provide back pressure control for the system 100, through operation of a flow restrictor 60 associated with the tank 10. These components also add complexity to the system.

As noted above, the tank 10 is normally a standard vented tank. However, pressure vessels have also been used to provide more stable pressure control to the distribution system. There are many variations on pressure vessel dispense systems, all of which have certain disadvantages. For example, multiple pressure vessels that operate in sequence can provide the most stable pressure for the system, but suffer from system complexity because of the need to continually pressurize, empty, vent and refill as liquid is circulated through the system. When a single pressure vessel is used, the liquid returning to the vessel must be first sent to a vessel at a lower pressure than is required for the dispense vessel and then pumped back into the dispense vessel. When liquid demand is low, significant energy is still consumed because of the necessity of maintaining the re-circulating flow.

There remains a need in the art to overcome the problems noted above.

### SUMMARY OF THE INVENTION

The present application provides methods and apparatus for the delivery of liquids under conditions that require highly accurate control of pressure or flow rate. In particular, the present invention provides methods and apparatus for the delivery of high purity chemicals or slurries to one or more points of use in a semiconductor manufacturing process, wherein the flow rate of the chemical or slurry is provided at a constant flow rate to the points of use.

The objectives of the present invention are accomplished by combining a pressure vessel and a centrifugal pump within the same distribution system. By using both a pressure vessel and a centrifugal pump together, the advantages provided by each component can be optimized and the overall performance of the system can be enhanced.

### BRIEF DESCRIPTION OF THE DRAWINGS

FIG. 1 is a schematic view of a basic system as known in the prior art.

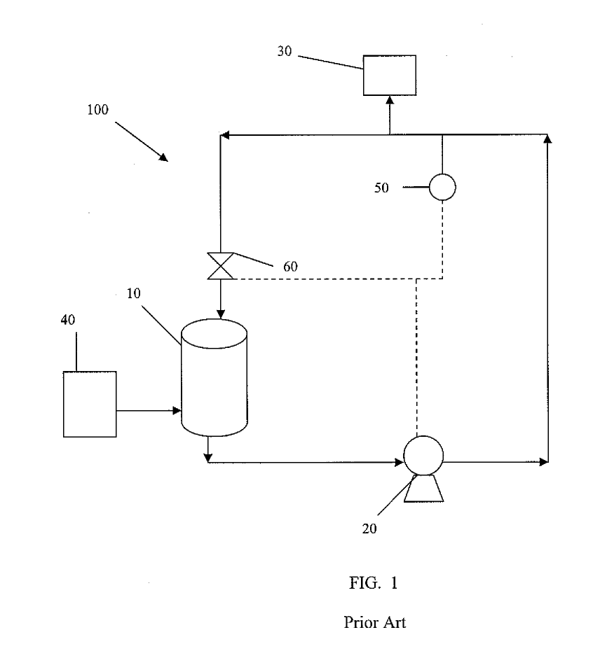

FIG. 2 is a schematic view of a basic system according to one embodiment of the present invention.

FIG. 3 is a schematic view of a further embodiment of the present invention showing optional components and arrangements of the system.

FIG. 4 is a schematic view of a further embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

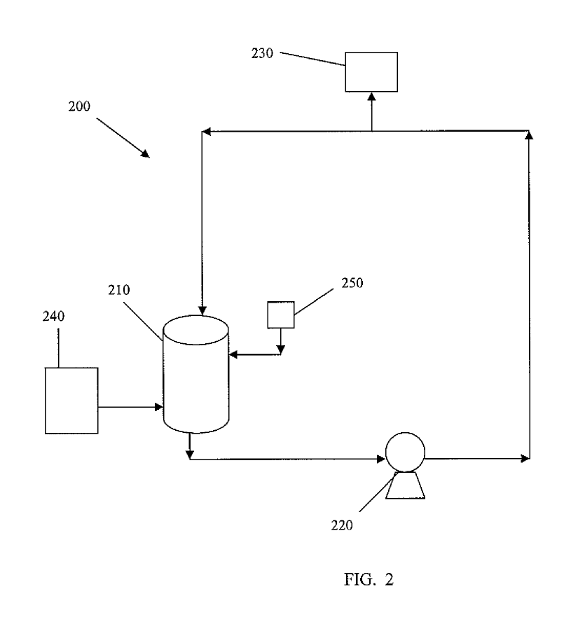

FIG. 2 is a schematic view of a basic system according to one embodiment of the present invention. In particular, FIG. 2 shows a liquid distribution system 200, comprising a pressure vessel 210 that can be refilled from a liquid source 240, a centrifugal pump 220, and a point of use 230. While only a single point of use 230 is shown, it will be recognized by those skilled in the art, that multiple points of use may be supplied with liquid using the same distribution system 200. Also shown is a pressure regulating means 250 that can be used to establish and maintain the appropriate pressure within pressure vessel 210. For example, regulating means 250 may comprise a nitrogen gas feed. The centrifugal pump 220 may be any corrosion resistant centrifugal pump such as those pumps manufactured by Levitronix®, LLC.

In operation, liquid is pumped through the system 200, by the centrifugal pump 220. Liquid is delivered out of the pressure vessel 210, and provided to the point of use 230. Any excess liquid is returned to the pressure vessel 210. Preferably, the return line would be submerged below the liquid level in the pressure vessel 210. Pressure within the system 200, is maintained by establishing the appropriate pressure within the pressure vessel 210, for example by pressurization using regulating means 250. The speed for the centrifugal pump 220 is also set appropriately to maintain the system 200 pressure at a desired level.

By using the pressure vessel 210 in conjunction with the centrifugal pump 220, significant advantages are achieved. In particular, by using a pressurized vessel 210, the centrifugal pump 220 can operate at lower speeds and still produce the required system 200 pressure. In this way, the system 200 according to the present invention requires much less energy than the systems of the prior art that utilize a standard vented tank. Further, by using the pressure vessel 210 and centrifugal pump 220, higher system pressure can be achieved than if a vented tank is used.

A further advantage of the present invention is that the regulated pressure of pressure vessel 220 serves to dampen pressure fluctuations during transient periods of operation. For example, the higher the pressure there is in pressure vessel 210, the more it will limit return flow, thus reducing frictional headloss. This provides a stabilizing effect on the pressure throughout the system 200.

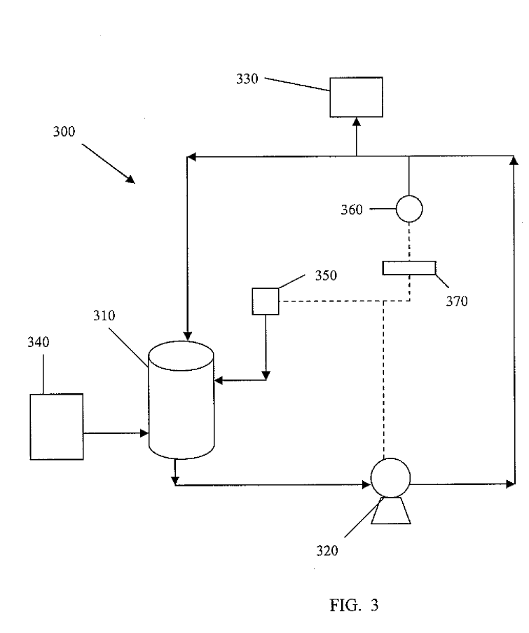

FIG. 3 is a schematic view of a further embodiment of the present invention showing optional components and arrangements of the system. In particular, FIG. 3 shows a liquid distribution system 300, comprising a pressure vessel 310 that can be refilled from a liquid source 340, a centrifugal pump 320, and a point of use 330. While only a single point of use 330 is shown, it will be recognized by those skilled in the art, that multiple points of use may be supplied with liquid using the same distribution system 300. Also shown is a pressure regulating means 350 that can be used to establish and maintain the appropriate pressure within pressure vessel 310. For example, regulating means 350 may comprise a nitrogen gas feed. Additional components are also included in the system 300, to provide for loop feedback control of the pressure and flow rate. A sensor 360 is provided to measure a condition of the liquid in the system 300. For example the sensor 360 may be a pressure sensor that measures the pressure of the liquid, or may be a flow meter to measure flow rate of the liquid. The sensor 360 provides a signal representing the measurement to a controller 370 that then sends a signal to other components of the system 300 to more accurately control pressure or flow rate within the system 300. For example, the controller 370 may send a signal to the pump 320 to adjust the speed of the pump 320 so that the measurement made by the sensor 360 remains constant. In other words, if the sensor 360 is a pressure sensor, then a signal representing the pressure of the liquid in the system 300 is sent to the controller 370. Based on this measurement, the controller determines whether an adjustment is needed to maintain constant pressure in the system 300, and if so, then sends a signal to appropriately adjust the speed of the pump 320. If the sensor 360 is a flow meter, the speed of the pump 320 can be similarly adjusted to reduce or increase flow rate as required to maintain a constant flow rate to the point of use 330.

Alternatively, the controller 370 may send a signal to the regulating means 350 to adjust pressure in the pressure vessel 310 as required to maintain constant pressure or flow to the point of use 330. One advantage of this alternative is that the centrifugal pump 320 can be operated at a constant speed, while the pressure of the pressure vessel 310 is adjusted to control system 300 operation.

A further alternative is to have the controller 370 provide signals to both the pump 320 and the regulating means 350 to maintain constant pressure and flow rate to the point of use 330.

While FIG. 3 includes only a single sensor 360, the present invention also includes embodiments having more than one sensor. For example, two pressure sensors could be utilized and both would provide signals to the controller 370. Based on these signals, the controller 370 could provide one output signal to the regulating means 350 to set pressure in the pressure vessel 310 and control pressure at the first sensor and another output signal to the pump 320 to control pump speed and control pressure at the second sensor. Other alternatives using flow meters in place of pressure sensors or combinations are also included. For example, the pressure of pressure vessel 310 could be adjusted to maintain pressure at a pressure sensor and the speed of pump 320 could be adjusted to maintain flow rate at a flow meter.

Other alternatives and embodiments are included in the present invention. For example, additional centrifugal pumps could be added to the system to provide back up and redundancy for the system. In addition, multiple pressure vessels could be utilized, either for back up and redundancy or to allow liquid blending to take place in one pressure vessel while another vessel is distributing liquid through the system. Isolation valves can be added to the system to allow for servicing. In addition, pressure relief valves could be provided to protect against failure of the pressure regulating means. Humidification can also be provided if needed, for example, by humidifying the nitrogen gas stream used for pressurization.

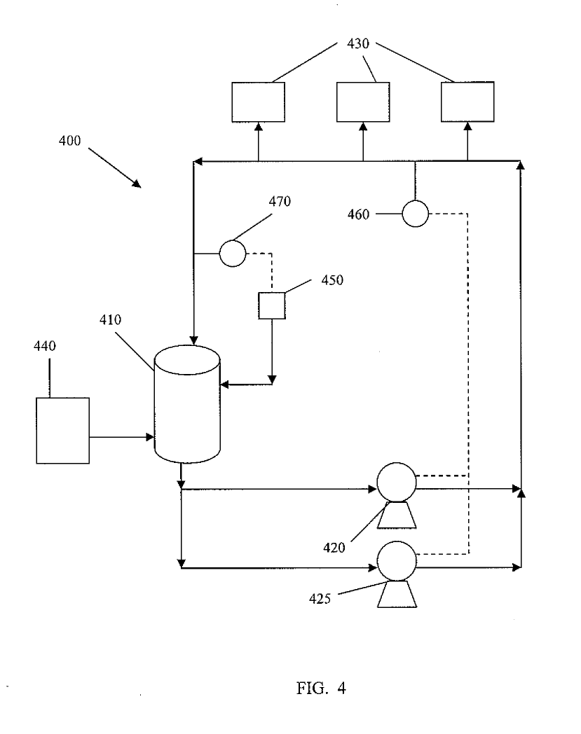

FIG. 4 is a schematic view of a further embodiment of the present invention. In particular, FIG. 4 shows a liquid dispensing system 400, comprising a pressure vessel 410, that can be refilled from a liquid source 440, such as a source drum or day tank, two centrifugal pumps 420, 425, and points of use 430. While multiple points of use 430 are shown in FIG. 4, it will be recognized by those skilled in the art that a single point of use could be supplied by the system 400. The centrifugal pumps 420 and 425 are redundant, i.e. one pump acts as a back up to the other. Further included in the system 400 is a regulating means 450 to control pressure within pressure vessel 410, a first sensor 460 that measures a condition of the liquid in the system 400 and produces a signal to control the speed of centrifugal pumps 420 or 425, and a second sensor 470 that measures a condition of the liquid in the system 400 and produces a signal to control the pressure of the pressure vessel 410. For example, the first sensor 460 may be a pressure sensor or a flow meter and can be utilized to control the speed of centrifugal pumps 420 or 425 in the same manner as set forth above with respect to FIG. 3. The second sensor 470 may also be a pressure sensor or a flow meter and can be utilized to control pressure within pressure vessel 410 in the same manner as set forth above with respect to FIG. 3.

Alternatives for the embodiment shown in FIG. 4 are the same as those mentioned above with respect to FIG. 3. In particular, additional centrifugal pumps could be added to the system to provide further back up and redundancy for the system. Multiple pressure vessels could be utilized, either for back up and redundancy or to allow liquid blending to take place in one pressure vessel while another vessel is distributing liquid through the system. In a particular embodiment, the pressure vessel may be a load cell so that liquid level in the pressure vessel can be determined at any time during operation. Isolation valves can be added to the system to allow for servicing. In addition, pressure relief valves could be provided to protect against failure of the pressure regulating means. Humidification can also be provided if needed, for example, by humidifying the nitrogen gas stream used for pressurization.

The present invention provides many advantages over the prior art by combining the favorable attributes of both pressure vessels and centrifugal pumps. In particular the centrifugal pumps of the system according to the present invention can operate at lower speeds and still produce the required system pressure. Therefore the systems according to the present invention require much less energy than the systems of the prior art that utilize a standard vented tank. Further, by using a pressure vessel and centrifugal pump together system pressures can be achieved than if a vented tank is used. A further advantage of the present invention is that the pressure vessel serves to dampen pressure fluctuations during transient periods of operation and provides a stabilizing effect on the pressure throughout the system 200.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

I/we claim:

1. A fluid distribution system comprising;
a centrifugal pump for dispensing fluid to a point of use;
a pressure vessel connected to the centrifugal pump wherein the centrifugal pump receives pressurized fluid from the pressure vessel;
a pressure regulating means for regulating pressure within the pressure vessel; and
a return line for returning a portion of the dispensed fluid to the pressure vessel.

2. The fluid distribution system of claim 1 further comprising a sensor positioned proximate the point of use for monitoring a condition of the fluid.

3. The fluid distribution system of claim 2 wherein the sensor is a pressure transducer.

4. The fluid distribution system of claim 2 wherein the sensor is a flow meter.

5. The fluid distribution system of claim 2 further comprising a controller.

6. The fluid distribution system of claim 5 wherein the controller is adapted to transmit a signal to the centrifugal pump and to the pressure regulating means, and to receive a signal from the sensor.

7. The fluid distribution system of claim 1 further comprising a fluid source connected to the pressure vessel.

8. The fluid distribution system of claim 1 further comprising a second centrifugal pump connected to the pressure vessel for dispensing fluid to the point of use.

9. The fluid distribution system of claim 2 further comprising a second sensor positioned in the return line wherein the second sensor is adapted to transmit a signal to the pressure regulating means.

10. The fluid distribution system of claim 1 wherein the pressure vessel is a load cell.

11. The fluid distribution system of claim 1 wherein the point of use is a semiconductor manufacturing process.

12. The fluid distribution system of claim 1 further comprising an inert gas source connected to the pressure regulating means to control pressure in the pressure vessel.

13. A method of controlling pressure in a fluid distribution system comprising:
controlling the speed of a centrifugal pump to maintain a predetermined pressure at a point of use;
controlling a pressure regulating means to maintain a predetermined pressure in a pressure vessel connected to the centrifugal pump; and
measuring a condition of the fluid with a sensor positioned proximate the point of use wherein the measured condition is used for controlling the speed of the centrifugal pump and the pressure regulating means.

14. The method of claim 13 further comprising transmitting a signal indicative of the measured condition from the sensor to a controller.

15. The method of claim 14 wherein the controller controls the speed of the centrifugal pump based upon the signal from the sensor.

16. The method of claim 14 wherein the controller controls the pressure in the pressure vessel based upon the signal from the sensor.

17. The method of claim 14 further comprising controlling the pressure in the fluid distribution system using feedback control wherein the controller receives the transmitted signal and sends a control signal to the centrifugal pump to adjust the speed.

18. The method of claim 17 wherein the controller sends a second control signal to the pressure regulating means to adjust the pressure in the pressure vessel.

19. The method of claim 14 further comprising controlling the pressure in the fluid distribution system using feedback control wherein the controller receives the transmitted signal and sends a control signal to the pressure regulating means to adjust the pressure in the pressure vessel.

20. The method of claim 14 further comprising measuring a condition of the fluid with a second sensor positioned proximate the pressure vessel.

21. The method of claim 20 further comprising transmitting a signal indicative of the measured condition from the second sensor to the controller

22. The method of claim 21 wherein the controller controls the speed of the centrifugal pump based upon the signal from second sensor.

23. The method of claim 21 wherein the controller controls the pressure in the pressure vessel based upon the signal from the second sensor.

24. The method of claim 21 wherein the controller controls the speed of the centrifugal pump and the pressure in the pressure vessel based upon both signals.

25. The method of claim 20 wherein the steps of measuring a condition of the fluid comprise measuring the pressure of the fluid.

26. The method of claim 20 wherein the steps of measuring a condition of the fluid comprising measuring the flow rate of the fluid.

27. The method of claim 13 further comprising controlling the speed of a second centrifugal pump.

28. The method of claim 13 further comprising transmitting a signal indicative of the weight or level of the fluid in the pressure vessel wherein the pressure vessel is a load cell.
